(19) United States
(12) Patent Application Publication
(10) Pub. No.: US 2016/0148523 A1
(43) Pub. Date: May 26, 2016

(54) Standardized Electronic Performance Impairment Analyzer

(71) Applicant: George Winston, Laguna Hills, CA (US)

(72) Inventor: George Winston, Laguna Hills, CA (US)

(21) Appl. No.: 14/946,741

(22) Filed: Nov. 19, 2015

Related U.S. Application Data
(60) Provisional application No. 62/082,771, filed on Nov. 21, 2014.

(51) Int. Cl. G09B 7/00; G06F 3/0484; G06F 3/0488

(52) U.S. Cl. CPC G09B 7/00; G06F 3/0488; G06F 3/04842

(57) ABSTRACT

The present invention is an apparatus and method for quantifying an individual's level of impairment, whether due to infirmity, substance use or mental state. This is performed through a test which measures a test subject ability to perform hand-eye activity tasks over a period of time and relating those results to a blood alcohol content equivalence table. The results of the test, along with the test subject's identifying data are then secured and uploaded to a secure database.

### CROSS-REFERENCE TO RELATED APPLICATION

This application claims the benefit of U.S. application Ser. No. 62/082,771, filed 21 Nov. 2014 which is incorporated herein by reference.

### FIELD OF THE INVENTION

The present invention relates to the field of testing and measurement, and more particularly to the field of diagnostic tests.

### BACKGROUND OF THE INVENTION

Impaired driving has long been a leading source of death and serious injury for motorists and pedestrians alike. Likewise, the impaired operation of aircraft, boats and heavy industrial equipment has led to many deaths and injuries. In order to determine whether an individual is under the influence, field sobriety tests are used by test administrators to assess the alcohol and narcotic impairment of test subjects. Frequently, test administrators are law enforcement or medical personnel and test subjects are suspects or patients. When properly administered and documented, field sobriety tests can be used to establish probable cause for an arrest or for a warrant to allow the gathering of evidence. Additionally, a properly administered and documented field sobriety test can be used as evidence at trial to support and justify the administration of biochemical testing of the test subject, as well as supporting the guilt of a test subject with respect to an offense for which alcohol or narcotic impairment is a required element of the offense. Further, field sobriety tests can be used to assess the condition of a patient during initial medical triage.

For many years, law enforcement has used blood alcohol content (BAC) levels as a quantifiable measurement of when someone is suspected of driving drunk. Alcohol levels, as measured by blood alcohol content (BAC) in terms of grams of alcohol per deciliter of blood (g/dL) are often used to determine an individual's level of impairment due to consumption of alcohol. For example, in the state of California, a user may be considered impaired if his/her BAC is over 0.04 and will automatically be considered impaired if the suspect's BAC level is greater than 0.08. At a BAC of 0.04 many individuals have slowed reaction times when performing complex tasks. Generally this involves subjecting a suspect to a breathalyzer test and/or collecting a blood sample for BAC level analysis.

Numerous scientific studies have noted the delayed reaction times and BAC levels. For example, some studies have shown that at a BAC of 0.08, the reaction time of the average driver doubles from 1.5 s to 3.0 s.

While these methods are effective in determining whether an individual is under the influence of alcohol, they are ineffective in determining whether an individual is impaired because he/she is under the influence of a drug, legal or illegal or, has some mental or physical impairment which makes it dangerous for them to operate a motor vehicle or heavy machinery. For example, it is well known the use of marijuana impairs reaction times; however, a BAC test will not show whether an individual is under the influence of marijuana.

In cases where a suspect is believed to be under the influence of marijuana or other drugs, the on-site law enforcement officer may resort to administering a field sobriety test in which the test subject engages. Examples include requiring a subject to stand on one leg, with arms outstretched for a period of time; and then requiring the suspect to perform physical tasks, such as raising an arm or touching their left hand to their nose, without falling over. Defense attorneys frequently attempt to challenge the admissibility of these field sobriety tests or argue to the magistrate that the results of such tests were tainted by improper administration therefore causing a false positive result. Additionally, such a defense may cause the results of a valid biochemical determination of intoxication to be ruled as inadmissible, if the field sobriety test used to justify the biochemical test is successfully challenged.

Therefore, there exists a need for rapidly and objectively quantifying an individual's level of impairment and securely recording the data for further use. The instant invention therefore satisfies a need for an objective method of quantifying impairment.

### SUMMARY OF THE INVENTION

An apparatus and software for testing whether an individual is impaired. The preferred embodiment of the apparatus is comprised of a touchscreen-enabled handheld device. Contained within the device are a central interconnect, processing unit, volatile and non-volatile memory power source, fingerprint scanner, camera, microphone, bar code and/or magnetic stripe reader, wireless data transmitter, USB ports, and USB peripherals such as a hand actuated momentary contact control switch.

A computer readable storage medium storing a program of instructions executable by a machine to perform one or more methods described herein is also provided.

A method for testing an individual for impairment, in its preferred embodiment comprises enabling a test subject to perform a series of tests to determine their reaction time. The test subject will be required to correctly select a series of moving or stationary visual targets; the test subject's average and individual reaction times, the number of correct responses and incorrect responses, will be recorded.

The method may comprise the display of a moving or stationary visual target of a certain color and a label next to the visual target listing the name of a color; the color of the visual target and the color listed on the label correctly match approximately 40% to 75% of the time. The test subject will then be required to depress said hand actuated momentary contact control switch.

Alternatively, the method may comprise the display of a moving visual target of a certain shape and a label next to the visual target listing the name of a shape; the shape of the visual target and the shape listed on the label correctly match approximately 40% to 75% of the time. The test subject will then be required to depress said hand actuated momentary contact control switch.

The method may also comprise: reading a test subject's identification documents via the bar code or magnetic stripe scanner; scanning the test subject's fingerprints via the fingerprint scanner; photographing test subject and/or the license plate of their automobile. The method may also comprise controls for a test administrator, including: restricted log-in requiring a test administrator identification or user name and password. The method may also comprise uploading the test results and test subject identification data to an off-site data base or cloud storage.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a schematic view of a testing device in accordance with an example embodiment of the present invention;

FIG. 2 illustrates a perspective view of a testing device in accordance with an example embodiment of the present invention with an attached momentary contact switch;

FIG. 3 illustrates a perspective view of a testing device in accordance with an example embodiment of the present invention with a user's hand operating the device with a STYLUS;

FIG. 4 illustrates a frontal view of a testing device in accordance with an example embodiment of the present invention;

FIG. 5 is a block diagram illustrating functions performed by a testing device in support of a test in accordance with an example embodiment of the present invention;

### DETAILED DESCRIPTION

Impaired driving is a serious problem in the United States and other countries around the world. Whether it is due to consumption of alcohol, use of licit or illicit drugs, fatigue, infirmity, old age or diminished mental capacity, it is well known that impaired individuals have slowed reaction times and general lowered levels of hand-eye coordination versus those of a sober or un-impaired individual. The following description relates to a system for quantifying an individual's level of mental impairment by recording the individual's psychomotor reaction times in the repeated performance of a task on a handheld device, such as a tablet or smartphone, according to a preferred embodiment of the present invention. The recorded psychomotor reaction time is then displayed in terms of the actual reaction time, a reaction time adjusted for the number of incorrect responses and equivalent BAC value derived from an imbedded look-up table. The data within the look-up table has been determined from actual performance measurements of human subjects' response times at various BAC levels. Individual tables are created for each test method embodiment.

For the purposes of this application, the “test administrator” is an individual administering and overseeing the conduct of the test; the “test subject” is the individual undergoing the test.

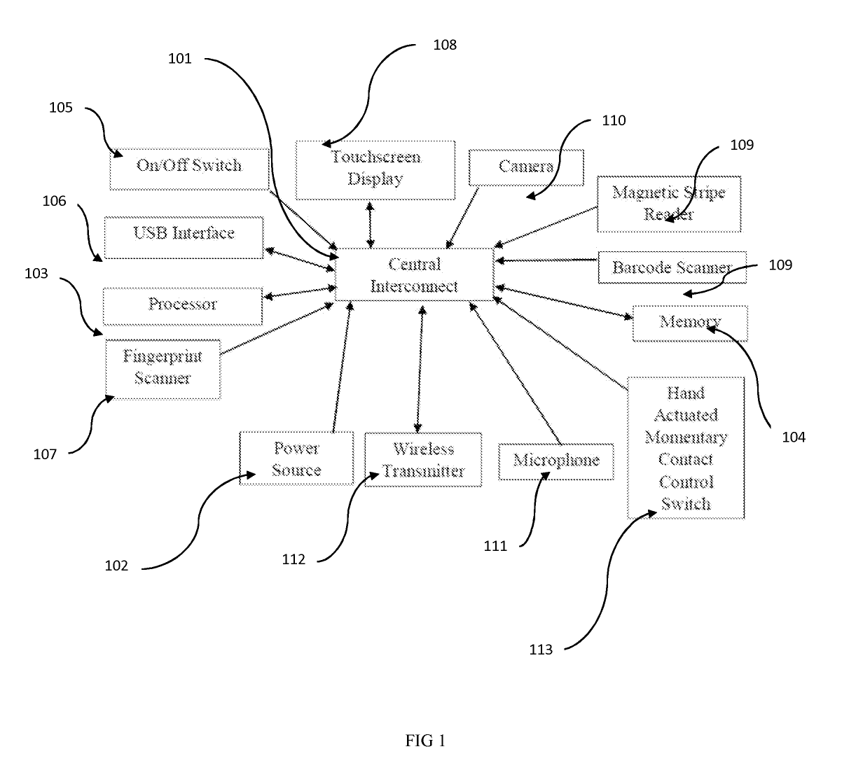

With reference now to the figures, and specifically with reference to FIG. 1, a schematic view of a handheld computing testing device in accordance with an example embodiment of the present invention is presented. The device includes a central interconnect 101, such as a circuit board or wires. The central interconnect 101 provides for connections among inputs, a power source 102, a processor 103, and volatile and non-volatile memory 104. Inputs can include an on/off button 105, a plurality of peripheral device connections 106, a fingerprint scanner 107, a visual touchscreen display 108, a bar code reader 109 or magnetic stripe reader 109, a camera 110, a microphone 111, a wireless transmitter 112, and a hand actuated momentary contact single or dual control switch 113.

The processor 103 can be provided to control the operation of device. As used herein, a processor 103 can include a programmable processor, such as a microcontroller, central processing unit (CPU), etc., or an application-specific integrated circuit (ASIC) or programmable logic array (PLA), such as a field programmable gate array (FPGA), designed to implement the functions performed by the device, such as control, data capture, and sound output. Memory 104 can be used to store data and instructions. The fingerprint scanner 107 can be used to capture a test subject's fingerprints, as well as verifying the identity and permissions of individuals changing user selectable settings of the device. The bar code reader 109 or magnetic stripe reader 109 can be used to capture the test subject's identification data, from an identification document, such as a driver's license, passport, school identification card, or other government issued identification. The camera 110 is used to capture an image of the subject, and optionally capture a video of the subject performing the test. The microphone 111 may be used to capture and record local sounds, such as the voices of the test subject and/or test administrator. The hand actuated momentary contact single or dual control switch 113 is used to signal the response to a visual challenge test, detailed below. The hand actuated momentary contact single or dual control switch 113 may either be a separate unit, wired to the handheld device or connected through a USB or other peripheral connection; a wireless connection; or a built into the handheld device.

The power source 102 may be embodied as one or more disposable batteries, or optionally, the combination of a rechargeable battery and a transformer or solar cells for receiving power. In some embodiments, the wireless transmitter 112 communicates with a cellular network, Wi-Fi internet connection or a Bluetooth connection. The peripheral device ports 106 may be any combination of mini-, micro- and/or full sized USB port, or other type of peripheral device connection.

Upon activation, the device is controlled by way of program instructions, in the form of a smart phone and tablet application. The program instructions enable a test administrator to collect identification and biometric data, and determine quantitatively, a test subject's reaction, and response time and precision (reflexes) to a visual stimulus, and display the information as actual time, in seconds and milliseconds, adjusted time, taking into account a specified time penalty for incorrect responses, and an equivalent BAC value.

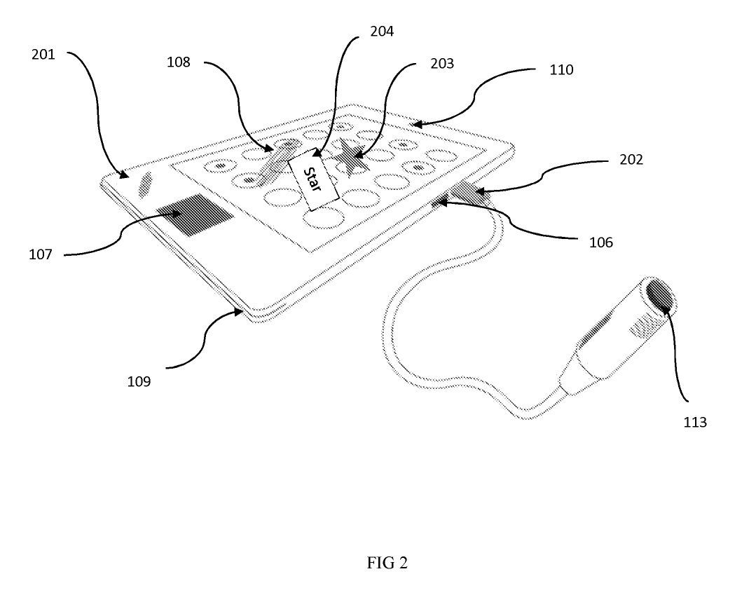

Turning now to FIG. 2, which illustrates a perspective view of preferred embodiment of a handheld computing testing device 201, using a hand actuated momentary contact single or dual control switch 113. Visible is the touchscreen display 108, fingerprint reader 107, camera 110, magnetic strip or barcode reader 109, and peripheral device connection ports 106. The hand actuated momentary contact control switch 113 is connected to one of the peripheral device connection ports 106; in this embodiment, the peripheral device connection ports 106 are connected through a USB connection 202 on the hand actuated momentary contact control switch. Visible on the touchscreen 108 are a visual target 203 and a label 204.

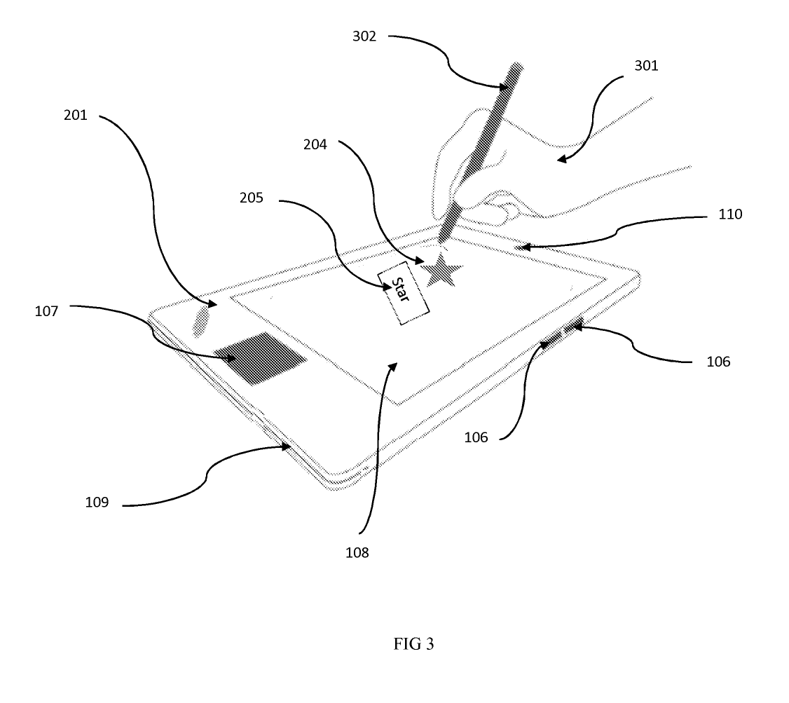

Turning now to FIG. 3, which illustrates a perspective view of an alternative embodiment of the device 201 being operated by a test subject 301, using a STYLUS 302. Visible is the touchscreen 108, fingerprint reader 107, camera 110, magnetic strip or barcode reader 109, and the peripheral device connection ports 106. Visible on the touchscreen 108 are a visual target 203 and a label 204.

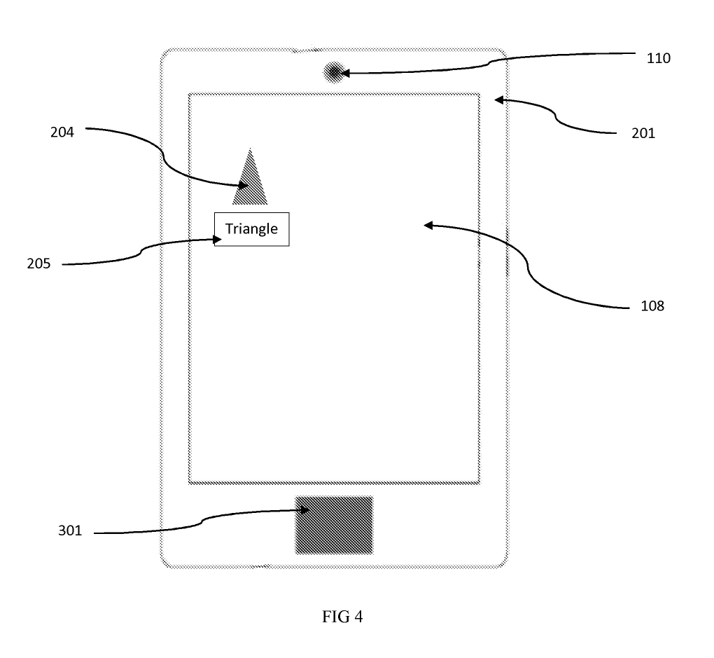

Turning now to FIG. 4, which illustrates a frontal view of a testing device 201 in support of a test in accordance with an example embodiment of the present invention. Visible are the camera 110, touchscreen 108 and fingerprint scanner 107. Visible on the touchscreen 108 are a visual target 203 and a label 204.

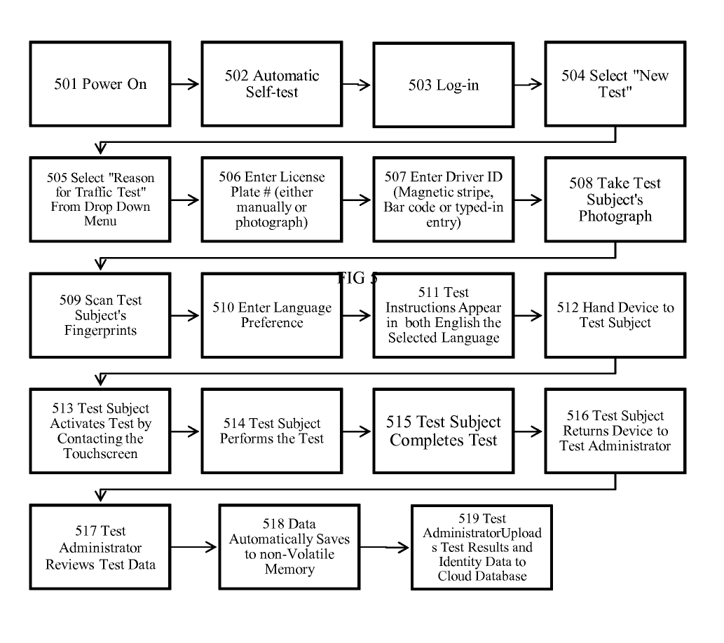

Turning now to FIG. 5, a flowchart diagram illustrating functions performed by a testing device in support of a visual challenge test to determine impairment in accordance with an example embodiment of the present invention. Power-up is initiated by means of a mechanical power switch on the surface of the device 501. Depressing the switch for approximately 2 seconds initiates a start-up process. The start-up process triggers a software and an automatic electronics diagnostic self-test 502.

If the automatic electronics diagnostic self-test fails 502, a message is displayed indicating that the device should not be used, along with an error code associated with the cause of the failed self-test. The error code is stored in a self-test results log. If the automatic electronics diagnostic self-test fails 502 is successful, with no errors detected, the touchscreen displays the current date, time, GPS location and battery state, along with a message asking the user to verify the date and time. Upon verification of date and time, the self-test results are stored in the self-test results log, and a program “Home Page” is displayed.

The “Home Page” display requests the test administrator to provide login information 503; such as a username or ID, password and/or fingerprint scan. Login information is verified against stored, authorized user information and is stored in non-volatile memory.

If the login information is not valid, the previously entered information is deleted from the data entry fields, and a message is displayed indicating “Login information is not valid—Please try again”. If login information is verified as valid, the display advances to a screen with a menu of choices. These choices are: “New Test”, “Review Data”, “Upload Data” & “Settings”. Each menu item, when selected will progress to another menu, as follows: “New Test” 504; “Review Test Data”; “Upload Records.”

To begin the testing, the test administrator will select “New Test”. The test administrator will then be instructed to enter the reason for the traffic stop, ex. driving infraction, brake light, exhaust, expired tag, etc. The test administrator will then be instructed to enter the reason for the test 505, ex. test subject is suspected of driving under the influence or erratic driving; followed by test subject's license plate number 506, either manually or by taking a photograph of the test subject's license plate; the test subject's identifying information from some form of issued identification document, ex. a driver's license or passport, which may entered by scanning a magnetic strip, bar code or by manual input 507. The test administrator will then take a photograph of the test subject 508. The next instruction to appear will instruct the test subject to place their finger on the finger print scanner, and activate the scanner by touching a button on the touch screen 509. The test administrator will then select the appropriate language 510, depending on the test subject. Instructions will appear in both English and the selected language to explain the process for taking the impairment analysis test 511. The test administrator will hand the device to the test subject 512.

The instructions will indicate the detailed procedure for taking the test, and ask the subject if the instructions are understood. The test subject will select their response by tapping the desired display icon. If “Yes” is tapped the device will change to a screen which displays an instruction to “‘Tap the “START’” button to begin test 513. When the “START” button is tapped the first timed response testing screen will be displayed, followed by subsequent testing screens, according to the testing algorithm. The test subject will then perform the test 514. Each testing screen will display a visual target. Under the preferred embodiment of this invention, the visual target will move randomly about the screen, at random speeds. Simultaneous with the display of the visual target, the device will start measuring elapsed time, until the test subject presses the hand actuated momentary contact control switch 113. When the test subject taps the hand actuated momentary contact control switch, the previously measured elapsed time will be stored into memory, and another timer will start to measure elapsed time. This second timer will trigger a repeat of the previous step upon reaching a randomly selected number of seconds, between 1 and 20. The test administrator may additionally select to use a fixed number of seconds within the 1 to 20 second range.

The previously described process will be repeated 5 to 25 times, depending on the consistency of the test subject's response times, with the number of cycles increasing as the level of consistency of the response times decreases. The number of repeated cycles will be calculated by an algorithm incorporated into the software.

Under one embodiment, a visual target is of a random color. A label displaying the name of a color will be displayed simultaneously with and just below the visual target. The target and label will move in unison. The name of the color specified on the label is pseudo-randomly the same as the actual color of said target or some other color, so that the name of the color on said label will match the color of the target between 40% and 75% of the time. The object of the test is for the user to correctly select, when the visual target's color matches that listed on the label. The algorithm will record the number of times the test subject correctly or incorrectly selects the target, as well as the response time.

Under a second embodiment, the visual target is of a random shape. A label displaying the name of a shape will be displayed simultaneously with and just below the visual target. The target and label will move in unison. The name of the shape specified on the label is pseudo-randomly the same as the actual shape of said target or some other shape, so that the name of the shape on said label will match the shape of the target between 40% and 75% of the time. The object of the test is for the user to correctly select, when the visual target's shape matches that listed on the label. The algorithm will record the number of times the test subject correctly or incorrectly selects the target, as well as the response time.

Under yet another embodiment, the device may be set so that the test is random, a test subject may receive any combination of the tests detailed above, independently of one another.

Under yet another embodiment of the device, the visual target test will utilize the device's touchscreen. Instead of pressing the hand actuated momentary contact control switch 113 during the course of the test, a test subject will tap the visual target on the touchscreen, whenever the name on the label matches the color or shape of the visual target

The previously described processes will be repeated 5 to 25 times, depending on the consistency of the test subject's selection of a correct label and target color or shape combination and response times, with the number of cycles increasing as the level of consistency of the correct responses and response times decrease. The number of repeated cycles will be calculated by an algorithm incorporated into the software.

Upon completion of the sequence of screens comprising the test 515. The device will display a message indicating the test is complete and instruction to tap a button labeled “Calculate Results” in order to view the test results. When the “Calculate Results” button is tapped, the device will display a screen showing the average response time to the test challenges, the number of correct responses, incorrect responses and missed taps, the number of adjusted seconds assessed due to incorrect responses, the adjusted average response time, equivalent BAC value.

The device will then be returned to the test administrator 516. Upon a pre-set time, elapsing from the time the “Calculate Results” button was tapped, another labeled button will appear on the display reading “Complete Test” when that button is tapped, two data entry fields will appear, requesting the test administrator to review the data 517 and re-enter their identifying information and password. Entering the requested information and tapping a “Done” button will cause the device to verify the identifying information and password, and if correct will cause the results to be stored to non-volatile memory 518.

The average response time to the test challenges, the number of correct responses, incorrect responses, missed taps, adjusted average time, and corresponding equivalent BAC value; and a signature box will appear on the screen with instructions for the test subject to sign and tap an “accept” button. The test administrator will then have the option of accepting the test or requiring the test subject to repeat. The test subject's fingerprint scan, identification data, test data and test results, will either be stored on the device for future download into a secured database or transmitted to a cloud based or local server via radio, Wi-Fi, Bluetooth or cellular technology 519.

Additional embodiments of the mobile computing device may not contain integrated magnetic stripe or bar code reader, and/or integrated fingerprint scanner. In this embodiment, the magnetic stripe or bar code reader would be an off the shelf external device which connects to the mobile computing device through a USB port or wirelessly through a short range connection, such as Bluetooth. The mobile computing device may also contain a built in flash memory card reader, for interface with the various available flash memory cards, such as secure digital (SD), micro SD, mini-SD, xD or memory stick.

Alternatively, under a third embodiment, the mobile computing device may be any of various types of devices. For example, mobile computing device may be a smartphone, such as an IPHONE™, ANDROID™ phone, Blackberry, etc. or mobile computing device may also be another type of portable computer, such as a tablet PC, e.g., an iPad. It is noted that current smartphone or tablet, such as the current iterations of the Galaxy S5™ or IPAD™, provide the various hardware capabilities required, including a processor, memory, a display, a microphone, speakers, camera, motion sensor, and a communications interface. Thus in one embodiment a software application is created, such as an IPHONE™ application or ANDROID™ application, which configures an existing smartphone or tablet to perform the operations described herein. For example, such an IPHONE™ application for conducting an impairment analysis test may be made available on the APPLE™ App Store for downloading by various IPHONE™ users.

It is to be understood that the foregoing is illustrative of the present invention and is not to be construed as limited to the specific embodiments disclosed, and that modifications to the disclosed embodiments, as well as other embodiments, are intended to be included within the scope of the appended claims. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

I claim:

1. A handheld computing device configured for use in conducting performance impairment analysis test, wherein the device comprises:
a. a housing;
b. a central interconnect;
c. a processor;
d. a power supply;
e. a wireless transmitter for communicating with a wireless network;
f. an antenna for performing wireless communications with the wireless computing network;
g. a processor comprised in the housing;
h. a non-volatile memory medium comprised in the housing, wherein the memory medium stores program instructions executable to capture biometric and identification data, implement said impairment analysis test and record the results of said test;
i. a touch enabled display screen;
j. wherein said touch enabled display screen is positioned in or on said housing.

2. The handheld computing device of claim 1, further comprising: a fingerprint scanner for recording fingerprints and program instructions computer-executable to implement recording of a user's fingerprints.

3. The handheld computing device of claim 1, further comprising: a device for capturing data from an identity document, and program instructions computer-executable to implement recording of data from said identity document; wherein said device for capturing data from an identity document is a bar code scanner and/or a magnetic stripe reader.

4. The handheld computing device of claim 1, further comprising a camera; wherein said camera is configured to capture still or motion images and program instructions computer-executable to implement recording of still or motion images.

5. The handheld computing device of claim 1, further comprising a hand actuated momentary contact single or dual control switch.

6. The handheld computing device of claim 1, wherein said handheld computing device is a smartphone or tablet.

7. The handheld computing device of claim 1, wherein program instructions executable to implement an impairment analysis test comprise program instructions computer executable to implement:
a. collection of user identification data for test subject and test administrator;
b. providing a visual target on a touchscreen of a touchscreen enabled, handheld computing device, wherein said visual target is moving randomly around said touchscreen, or is stationary on said touchscreen;
c. simultaneous with the display of the visual target, said program will start measuring elapsed response time until said user selects said visual target on said touchscreen, wherein, the previously measured elapsed time is stored into non-volatile memory;
d. repeating steps (b) and (c) up to 25 times;
e. averaging said response times;
f. wireless transmission of user's selections, timing of said selections, average of said response times to an off-site data base or cloud storage location; or storage of user's selections, timing of said selections and average of said response times.

8. The program instructions executable to implement the impairment analysis test of claim 6, wherein said visual target is of a random color and a corresponding label, spelling out the name of a color is placed below and moving with said visual target, t, or is stationary on said touchscreen; wherein the name of said color on said label will match the actual color of said visual target between 40% and 75% of the time; wherein the color of said visual target and color listed on said label change randomly, every time steps (b) and (c) of said program instructions are executed; wherein the number of correct responses, incorrect responses and response time are recorded.

9. The program instructions executable to implement the impairment analysis test of claim 6, wherein said visual target is of a random shape and corresponding label, spelling out the name of a shape is placed below and moving with said visual target, or is stationary on said touchscreen; wherein the name of said shape on said label will match the actual shape of said visual target between 40% and 75% of the time; wherein the shape of said visual target and shape listed on said label change randomly, every time steps (b) and (c) of said program instructions are executed; wherein the number of correct responses, incorrect responses and response time are recorded.

10. A method of use for a handheld computing device configured for use in performing an impairment analysis test, consisting of the steps of:
a. collecting and entering of user identification data of test subject and test administrator;
b. activating an impairment analysis test
c. providing a visual target on a touchscreen of a touchscreen enabled, handheld computing device, wherein said visual target is moving randomly around said touchscreen, or is stationary on said touchscreen;
d. simultaneous with the display of the visual target, said program will start measuring elapsed response time until said user selects said visual target, wherein, the previously measured elapsed time is stored into non-volatile memory;
e. storing the number of correct and incorrect selections;
f. repeating steps (c) and (d) of said method up to 25 times;
g. adding a specific number of seconds to the total response time for each incorrect selection or response;
h. averaging said response times;
i. wireless transmission of test subjects' identification data, selections, responses, timing of said selections and responses, average of said response times, with and without the inclusion of the seconds added for incorrect selections or responses; or local storage of test subject's identification data, selections, responses, timing of said selections and responses, average of said response times, with and without the time included for incorrect selections or responses.

11. The method of claim 9, wherein said visual target is of a random color and a corresponding label, spelling out the name of a color is placed below and moving with said visual target; wherein the name of said color on said label will match the actual color of said visual target between 40% and 75% of the time; wherein the color of said visual target and color listed on said label change randomly and independently of one another, every time steps (c) and (d) of said method are executed; wherein the number of correct responses, incorrect responses and response times are recorded.

12. The method of claim 9, wherein said visual target is of a random shape and corresponding label, spelling out the name of a shape is placed below and moving target with said visual target; wherein the name of said shape on said label will match the actual shape of said visual target between 40% and 75% of the time; wherein the shape of said visual target and shape listed on said label change randomly, every time every time steps (c) and (d) of said method are executed; wherein the number of correct responses, incorrect responses and response time are recorded.
